(19) United States
(12) Patent Application Publication
(10) Pub. No.: US 2007/0082326 A1
(43) Pub. Date: Apr. 12, 2007

(54) Imaging mechanism for wireless handheld devices, portable digital assistants, and other handheld computing devices

(76) Inventors: Matthew Nuffort, Lexington, MA (US); Jeffrey Hunt, Concord, MA (US)

Correspondence Address: Jeffrey Hunt, 58 Farmers Cliff Rd., Concord, MA, 01742, US

(21) Appl. No.: 11/544,917

(22) Filed: Oct. 7, 2006

Related U.S. Application Data
(60) Provisional application No. 60/724,728, filed on Oct. 7, 2005.

(51) Int. Cl. G09B 5/00

(52) U.S. Cl. 434/308

(57) ABSTRACT

A foldable stand that accommodates and supports multiple types of handheld devices, a means of clamping these devices in place to enable manipulation of the device's user interface, a camera for capturing a real-time video image of the handheld device's display, and a means of transmitting this image to a computer.

### RELATED APPLICATIONS

The present application is a continuation-in-part application of U.S. provisional patent application, Ser. No. US60/724,728, filed Oct. 7, 2005, for IMAGING MECHANISM FOR WIRELESS HANDHELD DEVICES, PORTABLE DIGITAL ASSISTANTS, AND OTHER HANDHELD COMPUTING DEVICES, by Matt Nuffort, Jeffrey Hunt, included by reference herein and for which benefit of the priority date is hereby claimed.

This patent application is a continuation of the provisional patent application filed by the same inventors under the same title on 7 Oct. 2005.

### FIELD OF THE INVENTION

The present invention relates to the means of transmitting the contents of a handheld device's screen into a computer so it can be recorded or shown on a larger screen or through the Internet to enable multiple parties to view the handheld device's screen at the same time and, more particularly, to a means of accommodating virtually all different sizes and types of handheld devices in a stable manner to allow their user interfaces to be manipulated while the content of the handheld device's screen is displayed.

### BACKGROUND OF THE INVENTION

Individuals and companies developing applications and content for wirelss and other handheld devices often want to demonstrate these applications to colleagues or to potential customers. The developers often hold collaborative internal meetings, conduct demonstrations through the Internet, attend trade shows and sales meetings, where they demonstrate their new applications using their devices. A problem arises, however, when multiple people want to watch the demonstration. Handheld device displays tend to be too small for multiple individuals to view at once. A means of displaying exactly what is on the handheld device's display on a larger screen for easier viewing or through the Internet by multiple individuals at once is needed. Also, law enforcement agents and criminal prosecutors often need to capture information from a handheld device to submit as evidence or to display at a trial.

There are numerous solutions in existence that address part of the problem. 1) Software solutions enable someone to connect a handheld device to a personal computer through a universal serial bus (USB) or similar connection. 2) Hardware solutions also exist that enable a person to connect hisa particular handheld device directly to a projector to project the device's display onto a larger screen. 3) Devices with cameras that take a real-time image of the handheld device's display and connect to a projector also exist. 4) Another solution for the problem is to emulate the handheld devices display in a simulation. 5) Solutions for capturing images from a handheld screen generally consist of non-commercial mechanisms involving a digital camera or video recorder.

1 & 2) The hardware and software solutions are device-specific. They do not work across the broad range of handheld device form factors and operating systems. Given the incredible diversity of handheld devices, it often is impractical for applications developers to focus on one particular device, and customers want to see applications that run on multiple type of devices. 3) The camera solutions in existence are often large and expensive, and they are not designed for the operation of handheld devices. Thus, they typically are not portable, or it is not practical to transport such devices, and/or they are not well suited for manipulating the handheld device's user interface while displaying an image of the device's screen. The camera devices also are not typically optimized for imaging the displays of handheld digital devices. For example, update rates for the camera must synchronize with the update rates of handheld device displays. 4) Customers often do not trust simulations, preferring instead to see new applications running real-time on actual handheld devices. They want to see exactly what the end customer will experience when using the application on an actual device. Simulations do not permit this. 5) With improvised solutions, it is difficult and time-consuming both to position the camera correctly relative to the handheld device screen, making it impractical to record all the useful evidence contained on a phone.

It is therefore an object of the invention to transmit the real-time image of a handheld device's display to a computer where it can be recorded, shown on a larger screen or through the Internet for viewing by multiple individuals at once.

It is another object of the invention to accommodate virtually any size or shape of handheld device and to accomodate different handheld operating systems and protocols.

It is another object of the invention to fasten the handheld device to a stable base to ensure the device does not move when manipulating the device's user interface, thereby enabling a real-time demonstration without unwanted movement of the screen and facilitating rapid recording.

It is another object of the invention to enable the user interface of each type of device to be accessed and manipulated easily and without interference.

It is another object of the invention to be compact and portable to enable the invention to be carried easily to trade shows, sales meetings, or other events or engagements requiring travel.

### SUMMARY OF THE INVENTION

In accordance with the present invention, there is provided a foldable stand that accommodates and supports multiple types of handheld devices, a means of clamping these devices in place to enable manipulation of the device's user interface, a camera for capturing a real-time video image of the handheld device's display, a mechanism for positioning the camera, and a means of transmitting this image to a personal computer from which it can be shown on a larger screen or recorded.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a mechanism with a camera and base to attach a handheld device and transmit a real-time image of the handheld device's display into a personal computer. The platform base is fully adjustable to accommodate multiple sizes and shapes of wireless devices. Knobs with threaded rods enable the vice grips to center and securely fasten the handheld device to the base. The camera attaches to a camera attachment, which accommodates a specific type of camera. The camera attachment is adjustably fastened to the pedestal, which is adjustable up and down with a ratcheting system, moving the camera further from or closer to the handheld device's screen to accommodate different sized screens. The platform base provides a stable platform for all handheld devices and enables a user to manipulate the user interface of the handheld device. The platform leg raises the platform base to an angle that enables the user to view the handheld device and manipulate the user interface;

FIG. 2 is a perspective view of a folded unit. The entire unit folds and stows into a small carrying case suitable for travel. Metal pins between the platform base and the platform leg and between the pedestal and the camera attachment enable the entire assembly to fold into a stowable unit. The pedestal collapses to reduce the size of the folded unit even further;

FIG. 3 is a side view of an unit. Clearly visible are the knobs that drive the vice grips back and forth to enable the unit to securely clamp a handheld device. The camera also is clearly visible attached to the camera attachment, which in turn is attached to the pedestal with a metal pin and holds the camera above the platform base. The pedestal and thereby the camera can be raised or lowered to create the appropriate zoom level for larger or smaller handheld device screens;

FIG. 4 is a perspective view of an entire unit with the camera extended. Clearly visible is the mechanism to position the camera directly over the handheld device screen. This sliding mechanism houses the camera and is adjustably fastening to the attachment to enable the camera to slide up or down to accommodate any type of handheld device;

FIG. 5 is a perspective bottom view of an extended camera assembly. The camera assembly comprises a camera holder, to hold the camera module, and a cover, to fasten the camera module in place. The cover and holder are fastened to each other with screws and clamp around the attachment, which attaches to the pedestal. A ratcheting mechanism, consisting of four plastic arms that bend as they move back and forth across corrugated plastic tracks, holds the camera assembly in position; and

FIG. 6 is a perspective bottom view of an open unit. It clearly shows the left and right-hand threaded rods that drive the vice grips. Left-hand-thread and right-hand-threaded nuts are inserted into the vice grips. Combined with the left-hand-threaded and right-hand-threaded rods, the vice grips move in opposite directions when the single knob is turned. This mechanism allows for automatic centering of the vice grips to ensure that the mobile device is positioned directly beneath the camera. A coupler connects the right-hand and left-hand threaded rods in the center.

For purposes of clarity and brevity, like elements and components will bear the same designations and numbering throughout the FIGURES.

### DESCRIPTION OF THE PREFERRED EMBODIMENT

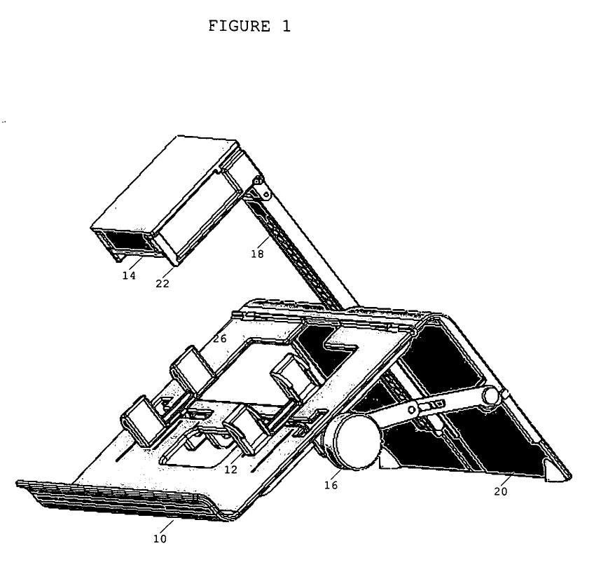

FIG. 1 is a perspective view of a mechanism with a camera 14 and base to attach a wireless handheld device and transmit a real-time image of the handheld device's display into a personal computer. The platform base 10 is fully adjustable to accommodate multiple sizes and shapes of wireless devices. A Knob 16 with left-hand-threaded rod 24 enables the vice grip 12 to securely fasten the handheld device to the base. A threaded left-hand-threaded nut 28 is press fit into the vice grip 12 to enable the left-hand-threaded rod 24 to translate the vice grip 12 back and forth. The camera 14 fastens to an attachment 22, which accommodates a specific type of camera 14. The attachment 22 is adjustably fastened to the Pedestal 18, which is adjustable up and down with a ratcheting system, moving the camera 14 further from or closer to the handheld device's screen to accommodate different sized screens. The platform base 10 provides a stable platform for all handheld devices and enables a user to manipulate the user interface of the handheld device. The Platform Leg 20 raises the platform base 10 to an angle that enables the user to view the handheld device and manipulate the user interface.

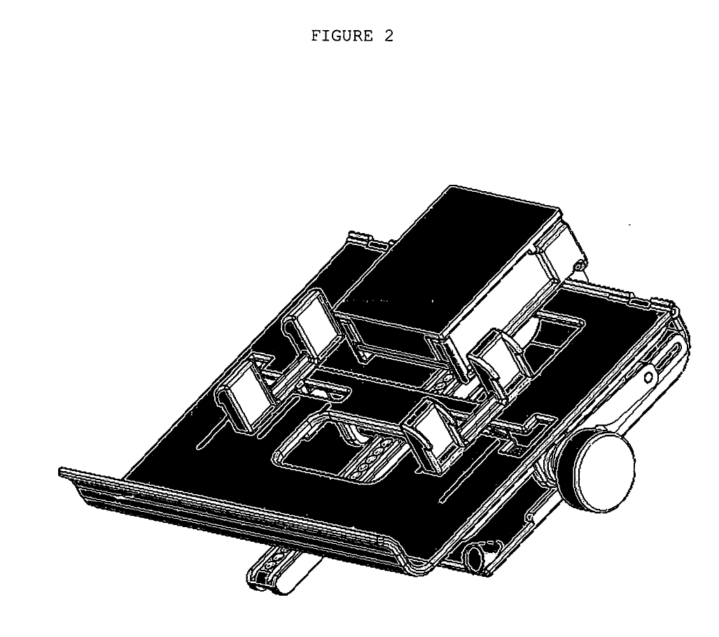

FIG. 2 is a perspective view of a folded unit. The entire unit folds and stows into a small carrying case suitable for travel. Metal pins 26 between the platform base 10 and the Platform Leg 20 and between the Pedestal 18 and the attachment 22 enable the entire assembly to fold into a stow-able unit. The Pedestal 18 collapses to reduce the size of the folded unit even further.

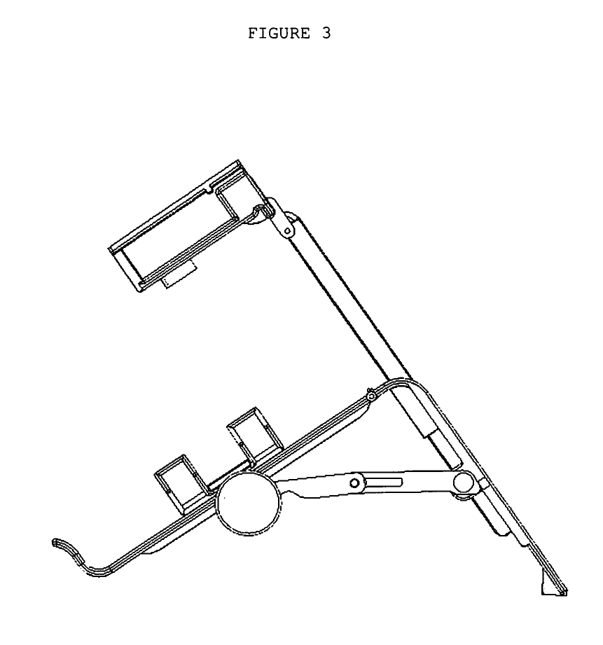

FIG. 3 is a side view of an unit. Clearly visible are the Knob 16 that drives the vice grip 12 back and forth to enable the unit to securely clamp a handheld device. The camera 14 also is clearly visible fastened to the attachment 22, which in turn is attached to the Pedestal 18 with a metal pin and holds the camera 14 above the platform base 10. The Pedestal 18 and thereby the camera 14 can be raised or lowered to create the appropriate zoom level for larger or smaller handheld device screens.

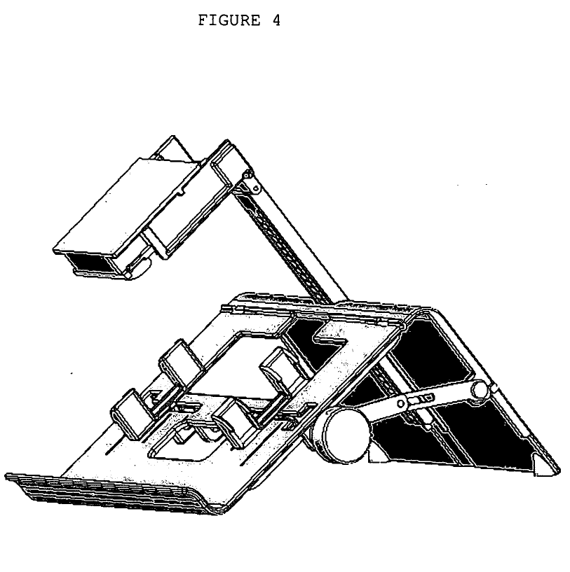

FIG. 4 is a perspective view of an entire unit with the camera 14 extended. Clearly visible is the mechanism to position the camera 14 directly over the handheld device screen. This sliding mechanism houses the camera 14 and is adjustably fastening to the attachment 22 to enable the camera 14 to slide up or down to accommodate any type of handheld device.

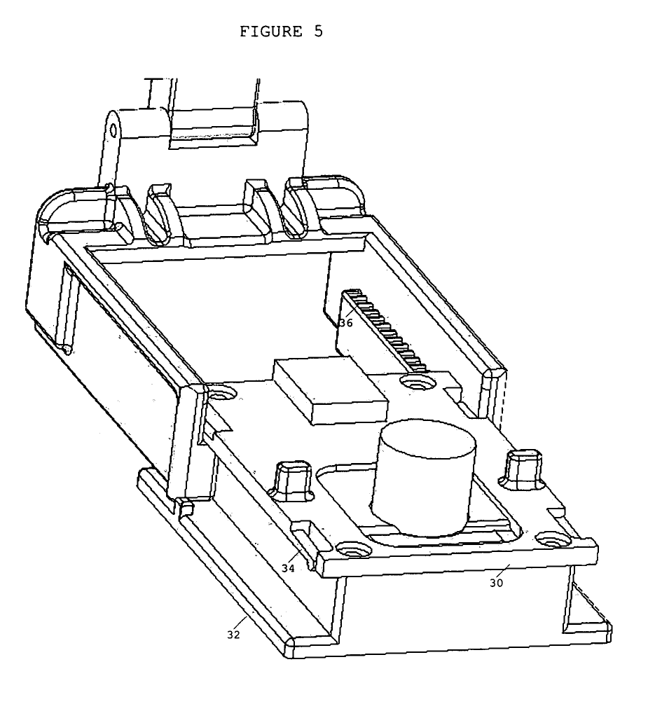

FIG. 5 is a perspective bottom view of an extended camera 14 assembly. The camera 14 assembly comprises a camera 14 holder 32, to hold the camera 14 module, and a cover 30, to fasten the camera 14 module in place. The cover 30 and holder 32 are fastened to each other with screws and clamp around the attachment 22, which attaches to the pedestal 18. A ratcheting mechanism 34, consisting of four plastic arms that bend as they move back and forth across corrugated plastic tracks, holds the camera 14 assembly in position.

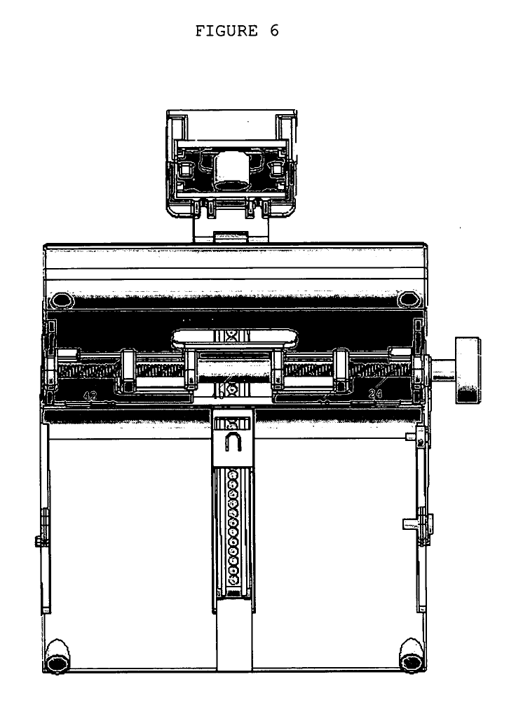

FIG. 6 is a perspective bottom view of an open unit. It clearly shows the left-hand-threaded rod 24 and right-hand threaded rod that drives the right and left vice grip 12, respectively. The left-hand-threaded nut 28 and right-hand-threaded nut 38 is inserted into the right and left vice grip 12 respectively. Combined with the left-hand-threaded rod 24 and right-hand-threaded rod 42, the left and right vice grips move in opposite directions when the single Knob 16 is turned. This mechanism allows for automatic centering of the vice grip 12 to ensure that the mobile device is positioned directly beneath the camera 14. A coupler 40 connects the right-hand-threaded rod 42 and left-hand-threaded rod 24 in the center.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An imaging mechanism for wireless handheld devices, portable digital assistants, and other handheld computing devices for transmitting a real-time image of a handheld device's screen into a computer from which it can be recorded or shown on a larger screen or through the internet for ease of viewing by multiple parties at once comprising:
means for aligning the camera with the handheld device and to accommodate all shapes and sizes of handheld devices;
means for clamping the handheld device in place to ensure it does not move when the user interface is being manipulated, adjustably attached to said means for aligning the camera with the handheld device and to accommodate all shapes and sizes of handheld devices;
means for capturing real-time video images of the handheld device's display;
means for raising and lowering the camera to accommodate handheld device screens of different sizes, including a ratcheting system for holding the camera at a set height, adjustably connected to said means for aligning the camera with the handheld device and to accommodate all shapes and sizes of handheld devices; and
means for precisely positioning the camera assembly along the vertical axis within a plane that is parallel to the mobile device screen.

2. The imaging mechanism for wireless handheld devices, portable digital assistants, and other handheld computing devices in accordance with claim 1, wherein said means for aligning the camera with the handheld device and to accommodate all shapes and sizes of handheld devices comprises a platform base.

3. The imaging mechanism for wireless handheld devices, portable digital assistants, and other handheld computing devices in accordance with claim 1, wherein said means for clamping the handheld device in place to ensure it does not move when the user interface is being manipulated comprises a vice grip.

4. The imaging mechanism for wireless handheld devices, portable digital assistants, and other handheld computing devices in accordance with claim 1, wherein said means for capturing real-time video images of the handheld device's display comprises a camera.

5. The imaging mechanism for wireless handheld devices, portable digital assistants, and other handheld computing devices in accordance with claim 1, wherein said means for raising and lowering the camera to accommodate handheld device screens of different sizes, including a ratcheting system fur holding the camera at a set height comprises a pedestal.

6. The imaging mechanism for wireless handheld devices, portable digital assistants, and other handheld computing devices in accordance with claim 1, wherein said means for precisely positioning the camera assembly along the vertical axis within a plane that is parallel to the mobile device screen comprises a ratcheting mechanism.

7. An imaging mechanism for wireless handheld devices, portable digital assistants, and other handheld computing devices for transmitting a real-time image of a handheld device's screen into a computer from which it can be recorded or shown on a larger screen or through the internet for ease of viewing by multiple parties at once comprising:
a platform base, for aligning the camera with the handheld device and to accommodate all shapes and sizes of handheld devices;
a vice grip, for clamping the handheld device in place to ensure it does not move when the user interface is being manipulated, adjustably attached to said Platform Base;
a camera, for capturing real-time video images of the handheld device's display;
a pedestal, for raising and lowering the camera to accommodate handheld device screens of different sizes, including a ratcheting system for holding the camera at a set height, adjustably connected to said Platform Base; and
a ratcheting mechanism, for precisely positioning the camera assembly along the vertical axis within a plane that is parallel to the mobile device screen.

8. The imaging mechanism for wireless handheld devices, portable digital assistants, and other handheld computing devices as recited in claim 7, further comprising:
a knob, for enabling the user to manipulate the vice grips back and forth to clamp the phone in place, adjustably attached to said Platform Base.

9. The imaging mechanism for wireless handheld devices, portable digital assistants, and other handheld computing devices as recited in claim 7, further comprising:
a platform leg, for raising the handheld device to enable the user to view the screen and manipulate the user interface, adjustably fastened to said Platform Base.

10. The imaging mechanism for wireless handheld devices, portable digital assistants, and other handheld computing devices as recited in claim 7, further comprising:
an attachment, for attaching a specific type of camera and for stowing the camera when the stand is folded, adjustably fastened to said Pedestal.

11. The imaging mechanism for wireless handheld devices, portable digital assistants, and other handheld computing devices as recited in claim 8, further comprising:
a platform leg, for raising the handheld device to enable the user to view the screen and manipulate the user interface, adjustably fastened to said Platform Base.

12. The imaging mechanism for wireless handheld devices, portable digital assistants, and other handheld computing devices as recited in claim 8, further comprising:
an attachment, for attaching a specific type of camera and for stowing the camera when the stand is folded, adjustably fastened to said Pedestal.

13. The imaging mechanism for wireless handheld devices, portable digital assistants, and other handheld computing devices as recited in claim 9, further comprising:
an attachment, for attaching a specific type of camera and for stowing the camera when the stand is folded, adjustably fastened to said Pedestal.

14. The imaging mechanism for wireless handheld devices, portable digital assistants, and other handheld computing devices as recited in claim 11, further comprising:
an attachment, for attaching a specific type of camera and for stowing the camera when the stand is folded, adjustably fastened to said Pedestal.

15. An imaging mechanism for wireless handheld devices, portable digital assistants, and other handheld computing devices for transmitting a real-time image of a handheld device's screen into a computer from which it can be recorded or shown on a larger screen or through the internet for ease of viewing by multiple parties at once comprising:
a platform base, for aligning the camera with the handheld device and to accommodate all shapes and sizes of handheld devices;
a vice grip, for clamping the handheld device in place to ensure it does not move when the user interface is being manipulated, adjustably attached to said Platform Base;
a camera, for capturing real-time video images of the handheld device's display;
a knob, for enabling the user to manipulate the vice grips back and forth to clamp the phone in place, adjustably attached to said Platform Base;
a pedestal, for raising and lowering the camera to accommodate handheld device screens of different sizes, including a ratcheting system for holding the camera at a set height, adjustably connected to said Platform Base;
a platform leg, for raising the handheld device to enable the user to view the screen and manipulate the user interface, adjustably fastened to said Platform Base;
an attachment, for attaching a specific type of camera and for stowing the camera when the stand is folded, adjustably fastened to said Pedestal; and
a ratcheting mechanism, for precisely positioning the camera assembly along the vertical axis within a plane that is parallel to the mobile device screen.
